(19) United States
(12) Patent Application Publication
(10) Pub. No.: US 2025/0383369 A1
(43) Pub. Date: Dec. 18, 2025

(54) METHOD OF AND SCANNING PROBE MICROSCOPY SYSTEM FOR MEASURING A TOPOGRAPHY OF A SIDE WALL OF A STRUCTURE ON A SURFACE OF A SUBSTRATE

(71) Applicant: Nearfield Instruments B.V., Rotterdam (NL)

(72) Inventors: Hamed SADEGHIAN MARNANI, Rotterdam (NL); Arseniy KALININ, Rotterdam (NL); Jakob VAN DE LAAR, Oosterhout (NL); Niranjan SAIKUMAR, Rotterdam (NL)

(21) Appl. No.: 18/879,281

(22) PCT Filed: Jun. 28, 2023
(86) PCT No.: PCT/NL2023/050353

§ 371 Date: Dec. 27, 2024

(30) Foreign Application Priority Data
Jun. 29, 2022 (NL) 2032315

(51) Int. Cl. G01Q 10/06; G01Q 20/00; G01Q 70/10

(52) U.S. Cl. CPC G01Q 10/06; G01Q 20/00; G01Q 70/10

(57) ABSTRACT

The present document relates to a method of measuring a topography of a side wall of a structure on a surface of a substrate using a scanning probe microscopy system. The system comprises a probe with a probe tip, and the substrate is supported on a substrate carrier. The method includes performing a measurement at a measurement point, which includes the steps of: moving the probe and the substrate carrier relative to each other to approach the probe tip towards the surface in a Z-direction perpendicular to the substrate surface; determining that the probe tip is located adjacent the side wall; establishing contact between the probe tip and the side wall; and obtaining a lateral position of the probe tip while in contact with the side wall, to determine a current position on the side wall. The step of establishing contact comprises a step of moving the probe tip relative to the substrate carrier in at least one lateral direction transverse to the Z-direction, by applying a non-oscillatory motion on the substrate carrier or the probe. The document further relates to a scanning probe microscopy device.

### FIELD OF THE INVENTION

The present invention is directed at a method of measuring a topography of a side wall of a structure on a surface of a substrate using a scanning probe microscopy system. The system comprises a probe with a probe tip, and the substrate is supported on a substrate carrier. The method includes performing a measurement at a measurement point, which includes the steps of: moving the probe and the substrate carrier relative to each other to approach the probe tip towards the surface in a Z-direction perpendicular to the substrate surface.

### BACKGROUND

Topography imaging of certain structures, in particular 3D samples with narrow and high aspect-ratio features that are abundant in the semiconductor or biomedical industry, with a scanning probe microscopy (SPM) system (such as an atomic force microscope (AFM)), may conventionally be performed using roughly two types of measurement methods.

In one of these types, a conventional probe tip is tilted such as to point the tip towards a sidewall to be measured. The structure including the to be measured sidewall is then measured by scanning the probe tip in one direction. Thereafter, from the opposite side of the structure, the probe tip may be pointed in the opposite direction such as to point towards the other sidewall, and the process may be repeated. To do so in both X and Y direction (defining the X and Y cartesian directions to be parallel to the substrate surface), the procedure must be performed four times—twice in each direction X and Y. This is rather slow and cumbersome, and moreover fails to provide a well working method of measuring sidewalls having a negative slope (i.e. overhanging side walls).

Another type of measurement methods is based on the usage of oscillatory imaging methods using specially-shaped probe tips that are oscillated in two orthogonal directions, typically Z and X (wherein Z is perpendicular to the surface and X is parallel to the surface in the scanning direction (Y is lateral to the scanning direction)). The various existing methods differ in implementation but typically have some aspects in common. These include actuating the probe or the sample in a direction perpendicular to the surface (in Z) with repeating motion profile, and with that motion profile extract topography in each pixel of the image upon reaching a pre-defined value of tip-sample interaction force. Within that motion profile, these aspects further include retracting the probe from the surface, and performing an oscillatory motion of the probe with respect to the surface in a direction parallel to the surface (typically X). The methods are typically performed using a specially shaped probe tip having a flared or a hammer-shaped cross section.

The latter type of measurements is faster and more accurate than the first type of measurements, because the shape of even overhanging sidewalls may be followed well. However, this measuring method still suffers from a number of disadvantages. The method typically requires driving probe at its resonant frequency when it is known that the oscillatory probe motion enlarges the operational footprint of the tip. This limits access to narrow trenches and openings. Therefore, high-aspect ratio structures and narrow structures cannot be measured using a resonating probe. Furthermore, only one orthogonal direction parallel to the surface can be measured, e.g. the X direction—where the X direction is defined to be the direction of the scanning motion of the probe along the surface (the Y direction being lateral with respect to the probe tip). It is thus not possible to map three dimensional structures in this manner, while this field of application is widely required in e.g. semiconductor manufacturing industry (e.g. defect inspection of 3D NAND structures). Also, upon probe exchange which has to be performed frequently, the existing methods require eight parameters (four per axis, X and Z) to be tuned, whereas various of these parameters are dependent on each other. Hence, probe exchange cannot be performed very efficiently.

### SUMMARY OF THE INVENTION

It is an object of the present invention to provide a method and system for performing scanning probe microscopy that overcomes the abovementioned disadvantages and enables efficient and accurate measuring of side wall topographies of structures on a surface of a substrate.

To this end, there is provided herewith a method of measuring a topography of a side wall of a structure on a surface of a substrate using a scanning probe microscopy system. The scanning probe microscopy system comprises a probe including a probe tip. A substrate carrier of the system in use supports the substrate, bearing the substrate surface. The method comprises performing a measurement at a measurement point including moving the probe and the substrate carrier relative to each other, such as to approach the probe tip towards the surface of the substrate in a Z-direction, the Z-direction being perpendicular to the substrate surface. The method also includes determining that the probe tip is located adjacent the side wall, and establishing contact between the probe tip and the side wall while the probe tip is located adjacent the side wall. A lateral position of the probe tip is obtained while the probe tip is in contact with the side wall, in order to determine a current position of the probe tip on the side wall. The step of establishing contact comprises moving the probe tip relative to the substrate carrier in at least one lateral direction, the lateral direction being transverse to the Z-direction, said moving being performed by applying a non-oscillatory motion on the substrate carrier or the probe in said lateral direction. The non-oscillatory motion may be applied using an actuator acting on the substrate carrier.

The present invention as described above, enables an efficient and accurate manner of measuring side wall topographies in one or two orthogonal directions parallel to the surface, while simultaneously enabling the Z-direction topography to be determined. The method is not limited to a single parallel direction at a time, but allows—where desired—to perform measuring three dimensional side wall structures such as trenches and cavities in a single pass. Furthermore, no complex parameter tuning is required upon probe exchange, because the measurement is a non-resonant and non-oscillatory measurement method, which is thus easier to tune for in absence of complex dynamics of the probe in use.

In a standard scanning probe microscopy (SPM) system, the substrate carrier may be driven by an XY-scanning actuator to perform a scanning motion underneath a probe head. The probe head, which includes the probe providing the cantilever and probe tip, may comprise a Z-type actuator to perform a Z-direction motion of the probe tip towards and or away from the surface. In such a system, the non-oscillatory motion in the direction parallel to the surface in accordance with the present invention, may be provided by using one or more additional actuators acting on the substrate carrier, e.g. piezo-type actuators.

Advantageously, the method of the present invention may likewise be applied in different types of scanning probe microscopy systems. For example, in a preferred embodiment the method may be applied in a scanning probe microscopy system, wherein the scan head including the probe also includes actuators (i.e. piezo type actuators) that enable to perform the relative motion in all three orthogonal directions X, Y and Z. The Z-motion enables to bring the probe tip towards and away from the surface, whereas the X-motion and Y-motion enable the probe to be scanned locally across the surface. This type of SPM system enables to apply multiple scan heads that may simultaneously perform topography mapping in multiple locations. In these types of systems, the non-oscillatory motion in accordance with the invention may be applied on either the substrate carrier or the probe. For example, the substrate carrier may be driven using an additional piezo type actuator that enables to perform the non-oscillatory motion. Alternatively or additionally, the scan head may include one or more further actuators that enable to add an additional X-direction or Y-direction motion. A further possibility, alternative or additional to the further actuators for the X and/or Y direction non-oscillatory motion, the scan head may include a controller that is configured (exclusively dedicated or as add-on functionality thereof) to control the existing X and Y actuators to perform the non-oscillatory motion in addition to the normal scanning motion. Various implementation possibilities are available to the skilled person.

In some embodiments, the step of determining the current position of the probe tip comprises at least one of: obtaining an X-position of the probe tip while the probe tip is in contact with the side wall, wherein the X-position relates to a position in a first lateral direction; or obtaining a Y-position of the probe tip while the probe tip is in contact with the side wall, wherein the Y-position relates to a position in a second lateral direction transverse to the first lateral direction; or obtaining a Z-position of the probe tip while the probe tip is in contact with the side wall, wherein the Z-position relates to a position in the Z-direction. The method of the present invention enables to accurately perform the lateral measurements, i.e. the measurements in the directions transverse to the Z-direction and parallel to the surface, in either a single lateral direction (e.g. X or Y-direction) or two lateral orthogonal directions (X and Y-direction). The latter enables to perform a three dimensional (3D) measurement of for example a trench or cavity. The two dimensional measurement, like the three dimensional measurement, may further be used to obtain information about e.g. the shape of a sidewall. For example a sidewall having a negative slope, i.e. an overhanging sidewall, may be accurately imaged in this manner.

In some embodiments, the method comprises, upon moving of the probe and the substrate relative to each other in the Z-direction, a step of detecting an impact of the probe tip on the surface of the substrate; and obtaining a Z-position of the probe tip upon said impact on the surface. For example, a control system of a scanning probe microscopy system may be configured for automatically registering this data upon detecting a deviation in a deflection of the probe while the probe is moved towards the substrate surface.

In some of these embodiments, the structure being examined is at least one structure of one or more structures on the surface, wherein the at least one structure has an apex defining a local maximum height of the structure in the Z-direction. The method in accordance with these embodiments includes scanning the probe relative to the surface, and performing the measurement for each measurement point of a plurality of measurement points during the scanning. Such method further comprises identifying the local maximum height from a plurality of obtained Z-positions of the probe tip upon impact on the surface of the substrate in said measurement points. This will enable the local maximum height to be determined. In particular, on a sample having cavities or trenches, this enables to determine the location and height of the edge. This data may be used as reference data, for example in other embodiments. The term ‘local maximum’ is to be understood in the mathematical meaning of the term, i.e.: a maximum within a restricted domain, especially a point on the surface whose height is greater than the heights of all other points on the surface in the vicinity. In other words, there may be (but not necessarily are) other structures on the surface as a whole having apexes which are located at a greater height. The structures may include structures that extend above a surface level, i.e. extending upwards in the Z-direction, and alternatively or additionally the structures may be provided by cavities or step-down structures going below the surface level in the Z-direction. For a cavity, the local maximum may typically be the surface level itself, and if there are multiple cavities on the surface the local maximum may for all of these cavities be provided by the surface level as highest local point of the structure. The skilled person will understand the meaning of the term ‘local maximum’ as described here.

In some of such embodiments, the step of determining that the probe tip is located adjacent the side wall is performed by comparing a current Z-position of the probe tip with the local maximum height identified, and identifying the probe tip to be adjacent the side wall when the Z-position is below the local maximum height. The local maximum may be derived in different ways, for example by comparing the current Z-position to a previous determined Z-position during scanning; or alternatively by measuring the local level of a sample surface during scanning or initialization. To enable the detection of the location of a side wall in the direct vicinity of a probe tip, the present embodiment enables to compare the current Z-position of the probe tip to the local heights in e.g. adjacent positions in the circumference of the present position. The location of the side wall may then be detected automatically, as well as the direction in which the side wall is location relative to the present position. This may be used to control the movement of the probe tip such as to map the shape of the side wall.

In some embodiments, for performing the step of obtaining the lateral position of the probe tip while the probe tip is in contact with the side wall, the step of establishing contact between the probe tip and the side wall is performed during said moving of the probe and the substrate carrier relative to each other in the Z-direction for approaching the surface. In these embodiments, the side wall will be contacted while moving the probe in the direction of the surface, which for example may be advantageous for detecting the shape of a negative slope of the side wall. In other or further embodiments, the method comprises, upon moving of the probe and the substrate relative to each other in the Z-direction, a step of detecting an impact of the probe tip on the surface of the substrate; the method further comprising: moving, upon detecting the impact of the probe tip on the surface of the substrate, the probe and the substrate relative to each other in the Z-direction, such as to move the probe tip away from the surface; wherein the steps of establishing contact between the probe tip and the side wall and obtaining the lateral position of the probe tip, is performed during said moving of the probe tip away from the surface. In these embodiments, the shape of the side wall may be detected when the probe is retracted on it's way back from the surface. The both of these embodiments together enable a highly accurate mapping of the shape of the side wall.

In some of the above embodiments, the step of obtaining the lateral position of the probe tip, further comprises maintaining contact between the probe tip and the side wall during said moving in the Z-direction and obtaining the lateral position at a plurality of Z-positions, such as to determine a shape of the side wall. The probe tip in this case is kept in contact with the surface in order to trace the shape of the surface, obtaining XYZ position data on it's way. Optionally, an algorithm or other data model, e.g. a machine learning data processing model, may be applied in order to predict a direction of change of the XYZ position of the side wall in the subsequently to be measured location. For example, the slope of the wall as detected in preceding points may be extrapolated with a certain margin. This may be used in order to correct the probe tip location while moving.

In some embodiments, the step of determining that the probe tip is adjacent a side wall comprises detecting that the probe tip is at least one of: adjacent multiple side walls; at least partially surrounded or enclosed by a side wall of a cavity; adjacent one or more side walls of multiple structures; adjacent one or more side walls in relation to multiple lateral directions; or adjacent a single side wall, such as a step-up or step down. Various data sources may be used in order to obtain this data, such as the abovementioned local maxima in Z-direction from the detected heights. Alternatively, this may be achieved by testing the presence of a side wall by means of probing in lateral different directions using a lateral test probing motion, to identify whether or not the probe tip will touch the side wall.

In some embodiments, the scanning probe microscopy system comprises one or more deflection sensors for obtaining a deflection sensor signal indicative of a deflection of the probe tip, one or more actuators for moving at least one of the probe or the substrate carrier, and a signal processing unit for analyzing the sensor signal and for controlling the actuators. In these embodiment, for identifying the probe tip to impact at least one of the surface or the side wall, the method for example comprises: determining, for detecting a deflection of the probe tip in the Z-direction, that the deflection signal is indicative of a pitch type rotation of the probe tip relative to a longitudinal axis through the probe, in response to a motion of the probe relative to the substrate carrier in the Z-direction. The system may for example, by the control unit, combine the data from the optical sensors with the data from the motion actuators, in order to detect a pitch deviation during moving in the Z-direction. Otherwise, such a method may additionally or alternatively comprise determining, for detecting a deflection of the probe tip in the X-direction, that the deflection signal is indicative of a pitch type rotation of the probe tip relative to a longitudinal axis through the probe, in response to a motion of the probe relative to the substrate carrier in an X-direction transverse to the Z-direction. The X-direction in this case may be defined as the direction wherein the cantilever extends. Otherwise, such a method may additionally or alternatively comprise determining, for detecting a deflection of the probe tip in the Y-direction, that the deflection signal is indicative of at least one of a roll type rotation or a yaw type rotation of the probe tip relative to a longitudinal axis through the probe, in response to a motion of the probe relative to the substrate carrier in a Y-direction transverse to the Z-direction.

In some embodiments, the probe tip comprises a longitudinal section and one or more lateral structures. The longitudinal section extends from the cantilever in a working direction, wherein the working direction as parallel to the Z-direction in use. The one or more lateral structures extend from the longitudinal section in a direction transverse to the working direction. For example, the probe tip thereby may have a hammerhead cross section. For example, the lateral structure may be the shape of a disk or square plate-like structure, or may include arms extending in a direction transverse to the working direction. The lateral structure advantageously enables to contact the side wall, also in the event of the side wall having a negative (overhanging) slope.

In accordance with a second aspect of the invention, there is provided a scanning probe microscopy system comprising a substrate carrier for supporting a substrate including a substrate surface, a sensor head including a probe comprising a cantilever and a probe tip arranged on the cantilever, a deflection sensor for obtaining a deflection sensor signal indicative of a deflection of the probe tip, and one or more actuators including: a Z-motion actuator for moving the probe tip or the substrate carrier in a Z-direction being a transverse direction relative to the sample surface, and a scanning actuator for moving the probe tip or the substrate carrier such as to move the probe tip relative to the substrate surface in a lateral direction which is transverse to the Z-direction, wherein the system further comprises a control unit configured for receiving the deflection sensor signal from the deflection sensor and for controlling the one or more actuators, wherein the control unit comprises a plurality of signal processing units, and wherein the control unit, for measuring a topography of a side wall of a structure on the surface of the substrate, is configured for performing a measurement at a measurement point including the steps of: moving, using the Z-motion actuator, the probe and the substrate carrier relative to each other for approaching the probe tip towards the surface in a Z-direction perpendicular to the substrate surface; determining that the probe tip is located adjacent the side wall; establishing, using the scanning actuator and the deflection sensor, contact between the probe tip and the side wall while the probe tip is located adjacent the side wall; and obtaining a lateral position of the probe tip while the probe tip is in contact with the side wall, such as to determine a current position of the probe tip on the side wall; wherein the step of establishing contact comprises a step of moving the probe tip relative to the substrate carrier in at least one lateral direction, the lateral direction being transverse to the Z-direction, wherein the moving is performed by applying a non-oscillatory motion on the substrate carrier or the probe.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIG. 1 schematically illustrates a scanning probe microscopy (SPM) system in accordance with an embodiment of the present invention;

FIGS. 2A-2C schematically illustrate different embodiments of probe heads for use in embodiments of the present invention;

FIG. 3 schematically illustrates how a probe in an embodiment of the invention responds to various forces exerted;

FIG. 4 schematically illustrates how forces may be sensed using an optical beam deflector in an embodiment of the invention;

FIG. 5 shows an example of the simultaneous measurements of structures using an embodiment of the invention;

FIG. 6 schematically illustrates a method in accordance with an embodiment of the present invention;

FIG. 7 schematically illustrates a method that enables to determine a local Z level of the surface in accordance with an embodiment of the invention;

FIG. 8 schematically illustrates a further embodiment of a probe tip design in accordance with the invention.

### DETAILED DESCRIPTION

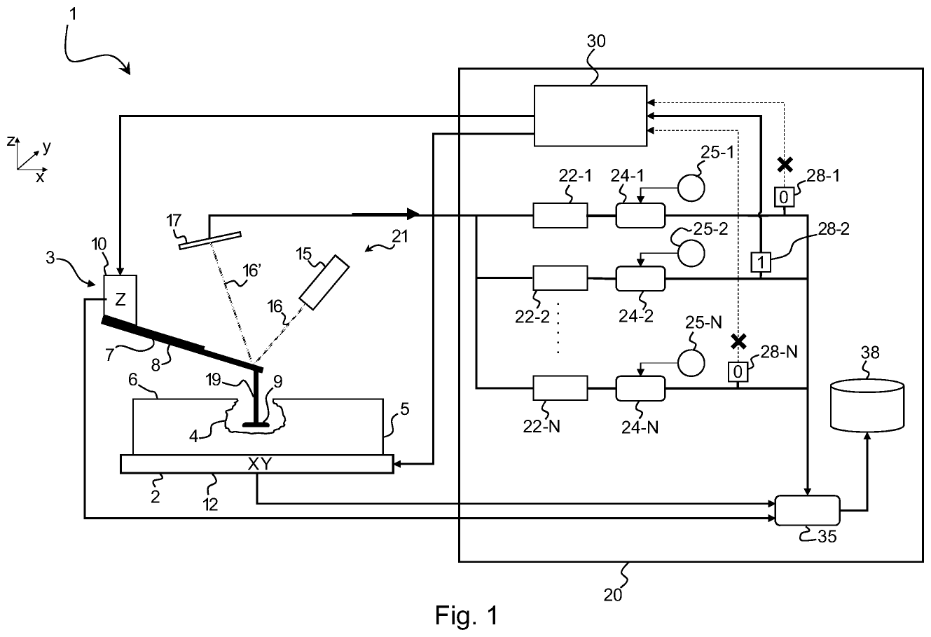

FIG. 1 schematically illustrates a scanning probe microscopy (SPM) system 1 in accordance with an embodiment of the present invention. In FIG. 1, only some parts of the SPM system 1 are illustrated, such as to not obscure the description with other parts of the system being of lesser importance to the invention. FIG. 1 schematically illustrates a sample carrier 2 bearing a sample 5 having a sample surface 6, and a scan head 3. The sample carrier 2 comprises an XY actuator 12 that enables to move the sample 5 relative to a probe 7 of the system 1 in a direction parallel to the carrier 2. The system 1 further comprises the scan head 3, including the probe 7 comprising a cantilever 8 and a probe tip 9. The scan head 3 may provide a mini SPM scan head of the system 1, where the system 1 may include multiple mini scan heads 3 (only one of which is illustrated in FIG. 1). Alternatively, the scan head 3 may be a main scan head of a type of SPM system comprising only a single scan head. The probe tip 9 is a special type of tip, having a hammer-shaped cross-section formed on an extension 19 extending from the cantilever 8. For example, to enable measuring in two parallel directions X and Y relative to the surface 6 of the substrate 5, the probe tip 9 may be shaped as a disk, square or cross having a cross-section similar to what is shown in FIG. 1. In use, for performing measurements of e.g. the topography of the sample 5 and/or the shapes of structures 4 (such as the internal shape of cavities or side walls of surface structures), the probe tip 9 is to be brought in contact with the surface 6 at least temporarily in order to determine for example the local height of the surface 6. When the probe tip 9 is in contact with the surface 6, the deflection of the tip 9 in general is different than when the probe tip 9 is not in contact with the surface 6. By sequentially bringing the probe tip 9 in touch with the surface 6, the local height of the sample 5 underneath the tip 9 may be determined. Therefore, by monitoring the deflection of the probe tip 9, measurements can be performed. The deflection of the probe tip 9 may be caused by deformation of the cantilever 8.

The probe 7 is mounted on a Z-position actuator 10 which enables it to be brought in contact with the sample surface 6 and be retracted there from in use. Optionally, the actuator 10 (or any auxiliary actuators thereto) may also enable a relative motion of the probe 7 in the X or Y direction. The actuators 10 and 12 are operated by a control unit 20 comprising a motion profile generator 30 that controls operation of the actuators. While measuring in the Z-direction, in principle, the probe tip 9 relative to the sample surface 6 does not move, or moves only slightly, in the XY direction. As further explained herein, for measuring the shape of a side wall or internal shape of a structure 4, non-oscillatory motion in an X or Y direction is applied by operating the actuator 12 or any available X or Y actuators auxiliary to actuator 10. If the probe 7 is to be moved to a next position, the probe tip 9 must be free from the surface 6 and must be retracted out of any cavities and away from structures with which it potentially could collide. To this end, for moving the probe tip 9 to a next pixel of the image to be made, the probe tip 9 is retracted from the surface 6 by the Z position actuator 10, and the XY actuator 12 is operated in order to move the probe 7 and the sample 5 relative to each other to a next pixel. Thereafter, the Z position actuator 10 is operated again in order to extend the probe 7 towards the surface 6 in order for the probe tip 9 to make contact therewith.

Measuring is performed using optical beam deflection units 21 comprising the laser 15 and optical sensors 17. Optical sensor 17 may for example be a four quadrant optical sensor that determines the shift of a spot formed by laser beam 16 and 16′ on the surface of the sensor 17. The beam 16 is provided by laser unit 15 which reflects on the backside of the probe 9 into reflected beam 16′. The optical beam deflector unit, using the optical sensor 17, provides at its output a deflection sensor signal indicative of a Z-direction deflection, an X-direction deflection or a Y-deflection, which is provided to the control unit 20.

To implement the invention, control unit 20 may comprise a plurality of signal processing units 22-1, 22-2, 22-i through 22-N. The number of signal processing units may be freely determined in the design, depending on the needs. Each of the signal processing units 22 may be associated with a corresponding triggering unit 24. Signal processing unit 22-1 is associated with triggering unit 24-1, signal processing unit 22-2 is associated with triggering unit 24-2 and so forth, such that signal processing unit 22-N is associated with triggering unit 24-N. It is not essential that each signal processing unit 22 is exclusively associated with a single triggering unit. For example, in some embodiments, a signal processing unit 22 may be associated with multiple different triggering units 24. In other or further embodiments, multiple signal processing units 22 may be linked to a same triggering unit 24. In other embodiments, some of the signal processing units 22 may not be linked to any triggering unit, but may pass on the processed signal e.g. for storage thereof in memory 38 or for use as input to central processing unit 35, e.g. to be used as input to some algorithm or process. Whether or not one or more triggering units 24 are associated with signal processing units 22, is dependent on the application and the requirements of the design at hand. Furthermore, each of the triggering units 24 compares the output of the signal processing unit 22 associated therewith with a condition 25. The triggering conditions 25-1 through 25-N can be predetermined by the operator of the SPM system 1. For example each of the triggering conditions 25-1 through 25-N may be different such that different triggering conditions may be checked by each of the triggering 24-1 through 24-N. Furthermore, at the output of the triggering units 24-N, trigger signals are provided which may be provided to central processing unit 35, e.g. for registration in memory 38 or for use as input to some algorithm or process. Furthermore, each of the output signals of the triggering unit 24-1 through 24-N may selectively also be provided to the motion profile generator 30. To this end, selector units 28-1 through 28-N may be associated with each of the triggering units 24-1 through 24-N. It is to be noted that such selector units are not essential in the system. The triggering signals may be dealt with by the motion profile generator 30 in a different way in case the selectors 28-1 through 28-N are absent. The central processing unit 35, upon receiving any trigger signal from any of the triggering units 24-1 through 24-N may perform a registration of the actuator positions of actuators 10 and 12 in the memory 38 (or optionally by accessing and registering in an external data repository, e.g. via a data communication network). Furthermore, the control unit 20, for example via the central processing unit 35, may also be configured for registering the output signals of optical sensor 17 upon receipt of a triggering signal via connection 33. Registered measurement data and actuator positions may be stored in a memory 38 of the SPM system, and/or used as input to some algorithm or process.

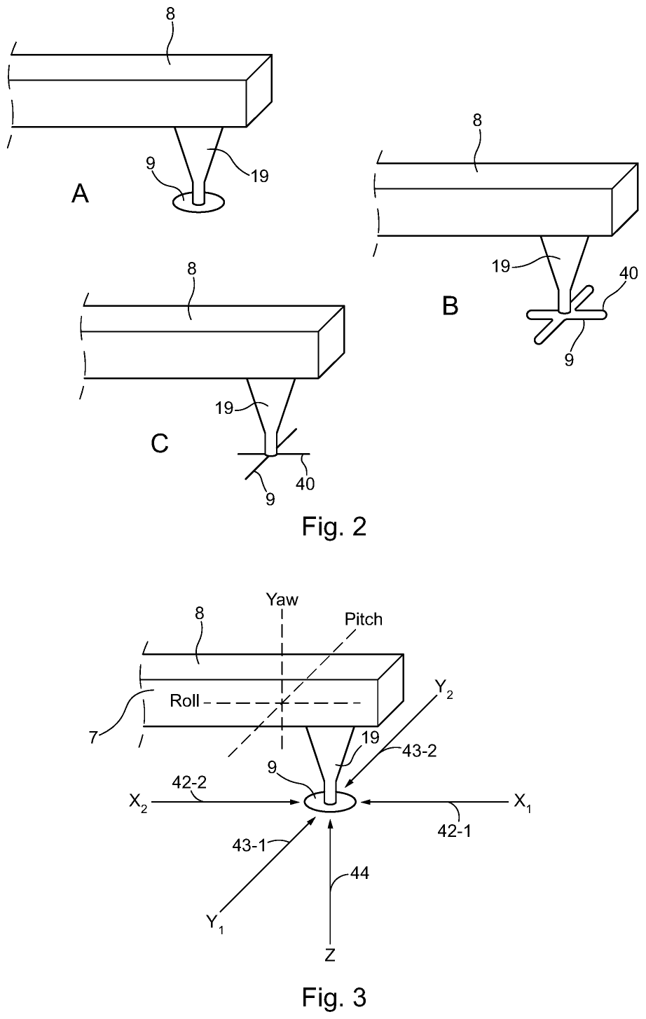

In FIGS. 2A, 2B and 2C, various different embodiments of probe heads that may be used in an embodiment of the method of the present invention are schematically illustrated. In FIG. 2A, at the end of cantilever 8, a longitudinal extension part 19 extends in a downward (Z) direction from the probe end. At the end of the longitudinal extension 19, the probe tip 9 is shaped as a flat disk like element. A similar probe is schematically illustrated in the system of FIG. 1, discussed above. The circular circumference of the disk shaped tip enables to exactly measure the side walls of the structure 4 to be measured. Due to the disk shape having the circular circumference, the ability to reach the side walls of the structure 4 are independent of the orientation of the probe with respect to the structure. In FIG. 2B, an alternative probe tip is schematically illustrated having a longitudinal section 19 extending from the cantilever 8. The tip 9 comprises four lateral extension structures 40 extending from the longitudinal extension 19. In this case, the probe of FIG. 2B is able to reach the side walls of structure 4 in the X and Y direction relative to the Z direction transverse to the surface 6. In the embodiment of FIG. 2C, a similar probe tip design is schematically illustrated having lateral cross-hairs 40 extending from the longitudinal extension, which enable to extend into small cavities of the side wall of the structure 4.

A further embodiment of a probe tip design is illustrated in FIG. 8. Here, the longitudinal extension 19 at the end thereof comprises the probe tip 9 which likewise slightly extend in the lateral direction forming a circular circumference 45. Below the circular circumference 45, a cone shape having an apex 46 extends the end of the longitudinal section perform a single contact part in the Z direction of the probe.

Back to FIG. 3, the probe tip of FIG. 2A is schematically illustrated. FIG. 3 illustrates how the cantilever 8 of the probe 7 may bend in response to the various forces experienced. From the combination of probe motion and probe deflection, it can be determined whether a specific bending of the cantilever of 8 of the probe is due to force in the X, Y or Z direction. This is illustrated in FIG. 3. For example, suppose that the probe 7 moves downward in the Z direction towards the surface, at some point the probe tip 9 will contact the surface 6 and will experience a force 44 in the opposite Z direction, which deflects in response thereto. This will cause the cantilever 8 to bend upward, thereby bending around the pitch axis illustrated in FIG. 3. Suppose, thereafter, the probe 7 will be moved in the positive X direction (i.e. the forward direction with respect to the probe), and at the side wall of a structure 4. In response to touching the side wall, the probe will experience a force 42-1 opposite to the movement direction. This will likewise cause the cantilever 8 to bend around the pitch axis of FIG. 3, albeit in the opposite direction compared to the rotation caused by the force 44. Thus, a forward movement of the probe 7 in combination with a positive rotation around the pitch axis is indicative of a force 42-1. If the probe 7 could be moved in the backward X direction, then likewise the force 42-2 experienced will bend the cantilever around the pitch axis in the negative rotation direction (anti-clockwise). Suppose the probe 7 could be moved in the sideways direction to the right, then upon touching the side wall of a structure 4, the probe tip would experience the force 43-1 in the Y direction. This will cause the cantilever 8 to bend around the roll axis or (if the force 43-1 is sufficiently large) around the yaw axis. Similarly, in the opposite direction, if the probe 7 will be moved to the left, the force 43-2 will likewise cause the cantilever 8 to deflect around the roll axis or yaw axis. Any of the above deflections, in combination in with the motion profile of the probe may be used in order to determine the exact X, Y and Z position of the touching edge of the probe tip 9 with the side wall of the structure 4.

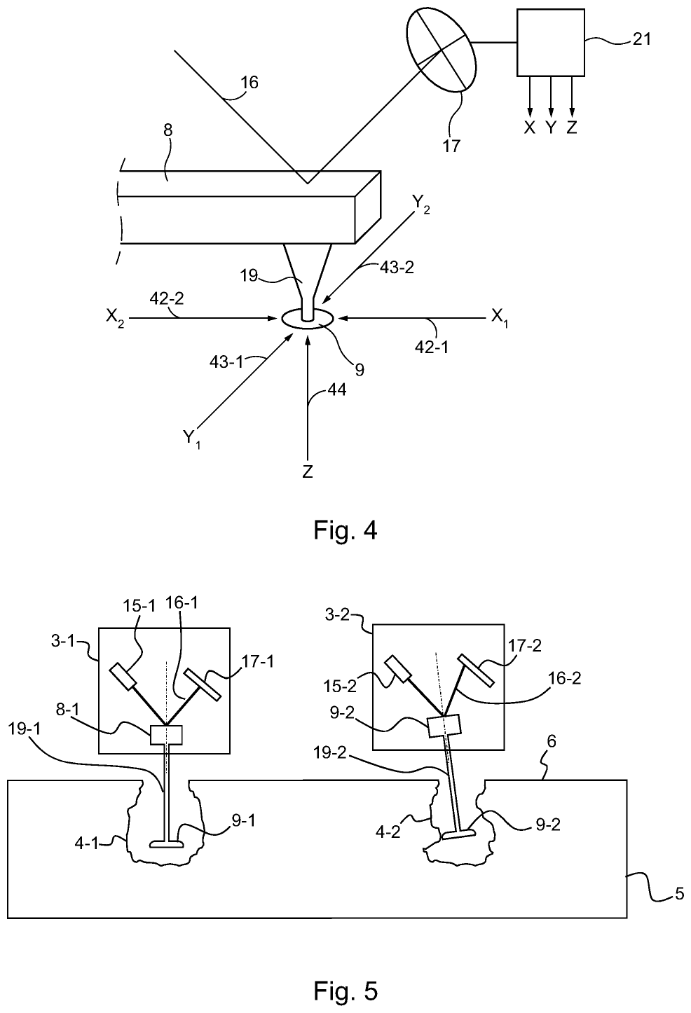

FIG. 4 schematically illustrates how any of the forces 42-1, 42-2, 43-1, 43-2 and 44 may be sensed using an optical beam deflector 17 in combination with a laser beam 16. The signal from the optical beam deflector 17 may be pre processed using a processor 21 to separate the X, Y and Z deflections therefrom. This may be passed on to the control unit 20 for further analysis.

Using the method of the present invention, in combination with an SPM system comprising multiple mini scan heads 3 as referred to with respect to FIG. 1, the plurality of structures 4 on the surface 6 of a substrate 5 may be measured simultaneously. FIG. 5 shows an example of the simultaneous measurements of two structures 4-1 and 4-2 on the surface 6 of the substrate 5. A first mini-scan head 3-1 measures the first structure 4-1 in the manner discussed above, and a second mini-scan head 3-2 measures the side wall of structure 4-2 in a similar manner simultaneously. Both the mini-scan heads 3-1 and 3-2 in FIG. 5 are illustrated in front view. As can be seen, the tip 9-2 of the second mini scan head 3-2 touches the side wall 4-2, causing the cantilever 8-2 to rotate around its longitudinal axis.

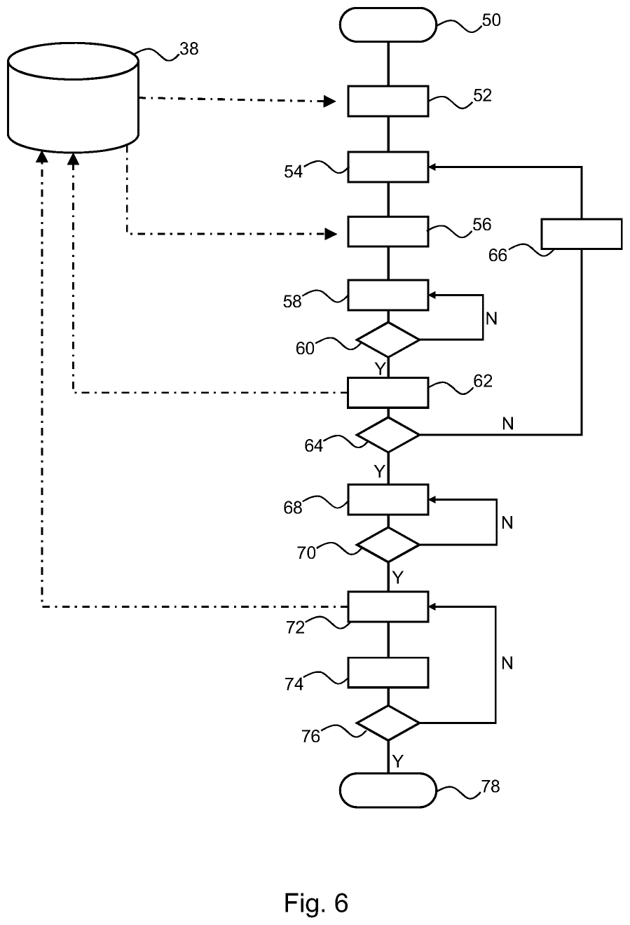

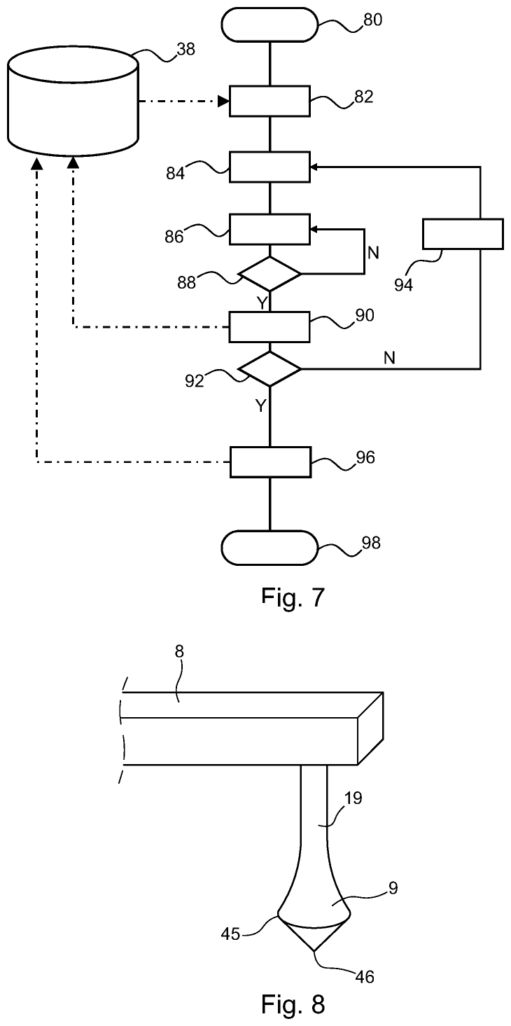

The method of the present invention is schematically illustrated in FIG. 6. Starting in 50, the method starts by obtaining a first XY position of a scan pattern to be performed on the surface 6 of the substrate. This data is obtained in step 52. Then in step 54, the scan head moves the probe tip towards the XY position, and in step 56 the local maximum Z level of the surface may be obtained from the memory 38. In FIG. 7 below, a method will be discussed that enables to determine a local Z level of the surface, however the skilled person will appreciate that other methods may likewise be applied. Back to FIG. 6, in step 58 the probe tip 9 is moved towards the substrate surface 6. Then in step 60, it is determined whether or not the probe tip 9 has contacted the surface 6 by sensing impact thereof. Is this is not the case, the process returns to step 58 to further lower the probe tip 9. If impact of the probe has been detected, then in step 62 the Z level is recorded in memory 38. Then in step 64, it is determined whether or not the probe tip is adjacent a side wall of a structure 4. This step may be performed by comparing the current Z position of the probe tip with the local Z level obtained in step 56 above. If from this comparison, it is determined in step 64 that the probe tip is not adjacent a side wall of a structure, that in step 66 a next XY position is determined of the scan pattern, and the method continues again in step 54.

However in case the probe tip 9 is indeed adjacent a side wall of a structure 4, then in step 68 a lateral movement is made with the probe 7 in order to move the probe tip 9 towards the side wall of the structure 4. In step 70 it is determined whether the probe tip is in contact with the side wall of the surface 4. If this is not the case, the method continues with step 68, however if contact is registered, then in step 72 the X, Y and Z position of the probe tip 9, is registered in the memory 38. Next, in step 74 the probe tip is moved upwards, away from the surface 6 and in step 76 it is determined whether the probe tip is free from the surface 6 and no longer adjacent a side wall. If this is not the case (the probe tip is still adjacent a side wall), the X, Y and Z position of the probe tip is again registered. It is important that the measurement is performed while the probe tip 9 is in touch with the side wall of the structure 4. Thus, the feedback control mechanism may be applied between steps 76 and 72 to maintain contact. If the probe tip has left the surface 6 and is no longer adjacent a side wall of a structure 4, then the method may end in step 78 or may continue with a next XY position in step 54.

FIG. 7 schematically illustrates the determination of the local maximum height of the substrate surface. In step 82, again a scan pattern is obtained and the first part of the scan pattern is determined in step 82. Then in step 84, the probe tip is moved to the first part in the scan pattern, and in step 86 the probe tip is lowered towards the surface. In step 88 it is determined whether the probe tip has impacted the surface and if this is not the case, the method returns back to step 86. Otherwise, if impacted registered, then in step 90 the Z position of the probe tip is registered in the memory 38. In step 92, it is determined whether or not the measured position is the last position in the scan pattern. If this is not the case, then in step 94 a next XY position of the scan pattern is obtained and the method returns to step 84. Otherwise, if the last point in the scan pattern has been measured, then in step 96 from all determined Z positions of the surface, the local maximum Z levels of the surface are determined for use in the method described above. Thereafter, the method may be ended in step 98.

The present invention has been described in terms of some specific embodiments thereof. It will be appreciated that the embodiments shown in the drawings and described herein are intended for illustrated purposes only and are not by any manner or means intended to be restrictive on the invention. It is believed that the operation and construction of the present invention will be apparent from the foregoing description and drawings appended thereto. It will be clear to the skilled person that the invention is not limited to any embodiment herein described and that modifications are possible which should be considered within the scope of the appended claims. Also kinematic inversions are considered inherently disclosed and to be within the scope of the invention. Moreover, any of the components and elements of the various embodiments disclosed may be combined or may be incorporated in other embodiments where considered necessary, desired or preferred, without departing from the scope of the invention as defined in the claims.

In the claims, any reference signs shall not be construed as limiting the claim. The term ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the structure of the invention within its scope. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Additions, deletions, and modifications within the purview of the skilled person may generally be made without departing from the spirit and scope of the invention, as is determined by the claims. The invention may be practiced otherwise then as specifically described herein, and is only limited by the appended claims.

1. A method of measuring a topography of a side wall of a structure on a surface of a substrate using a scanning probe microscopy system, the scanning probe microscopy system comprising a probe including a cantilever and a probe tip, wherein the substrate is supported on a substrate carrier, the method comprising performing a measurement at a measurement point including the steps of:
moving the probe and the substrate carrier relative to each other, to approach the probe tip towards the surface of the substrate in a Z-direction, the Z-direction being perpendicular to the substrate surface;
determining that the probe tip is located adjacent the side wall;
establishing contact between the probe tip and the side wall while the probe tip is located adjacent the side wall; and
obtaining a lateral position of the probe tip while the probe tip is in contact with the side wall, to determine a current position of the probe tip on the side wall;
wherein the step of establishing contact is performed by a step of moving the probe tip relative to the substrate carrier in at least one lateral direction until contact between the probe tip and the side wall is established, the lateral direction being transverse to the Z-direction, said moving being performed by applying a non-oscillatory motion on the substrate carrier or the probe in said lateral direction.

2. The method according to claim 1, wherein the step of determining the current position of the probe tip comprises at least one of:
obtaining an X-position of the probe tip while the probe tip is in contact with the side wall, wherein the X-position relates to a position in a first lateral direction; or
obtaining a Y-position of the probe tip while the probe tip is in contact with the side wall, wherein the Y-position relates to a position in a second lateral direction transverse to the first lateral direction; or
obtaining a Z-position of the probe tip while the probe tip is in contact with the side wall, wherein the Z-position relates to a position in the Z-direction.

3. The method according to claim 1, wherein the method comprises, upon moving of the probe and the substrate relative to each other in the Z-direction, a step of detecting an impact of the probe tip on the surface of the substrate; and obtaining a Z-position of the probe tip upon said impact on the surface.

4. The method according to claim 3, wherein the structure is at least one structure of one or more structures on the surface, the at least one structure having an apex defining a local maximum height of the structure in the Z-direction; wherein the method comprises scanning the probe relative to the surface, and performing the measurement for each measurement point of a plurality of measurement points during the scanning, further comprising identifying the local maximum height from a plurality of obtained Z-positions of the probe tip upon impact on the surface of the substrate in said measurement points.

5. The method according to claim 4, the step of determining that the probe tip is located adjacent the side wall is performed by comparing a current Z-position of the probe tip with the local maximum height identified, and identifying the probe tip to be adjacent the side wall when the Z-position is below the local maximum height.

6. The Method according to claim 1, wherein for performing the step of obtaining the lateral position of the probe tip while the probe tip is in contact with the side wall, the step of establishing contact between the probe tip and the side wall is performed during said moving of the probe and the substrate carrier relative to each other in the Z-direction for approaching the surface.

7. The method according to claim 1, wherein the method comprises, upon moving of the probe and the substrate relative to each other in the Z-direction, a step of detecting an impact of the probe tip on the surface of the substrate; the method further comprising:
moving, upon detecting the impact of the probe tip on the surface of the substrate, the probe and the substrate relative to each other in the Z-direction, to move the probe tip away from the surface;
wherein the steps of establishing contact between the probe tip and the side wall and obtaining the lateral position of the probe tip, is performed during said moving of the probe tip away from the surface.

8. The method according to claim 6, wherein the step of obtaining the lateral position of the probe tip, further comprises maintaining contact between the probe tip and the side wall during said moving in the Z-direction and obtaining the lateral position at a plurality of Z-positions, to determine a shape of the side wall.

9. The method according to claim 1, wherein the step of determining that the probe tip is adjacent a side wall comprises detecting that the probe tip is at least one of: adjacent multiple side walls; at least partially surrounded or enclosed by a side wall of a cavity; adjacent one or more side walls of multiple structures; adjacent one or more side walls in relation to multiple lateral directions; or adjacent a single side wall.

10. The method according to claim 1, wherein the scanning probe microscopy system comprises one or more deflection sensors for obtaining a deflection sensor signal indicative of a deflection of the probe tip, one or more actuators for moving at least one of the probe or the substrate carrier, and a signal processing unit for analyzing the sensor signal and for controlling the actuators, wherein for identifying the probe tip to impact at least one of the surface or the side wall, the method comprises at least one of:
determining, for detecting a deflection of the probe tip in the Z-direction, that the deflection signal is indicative of a pitch type rotation of the probe tip relative to a longitudinal axis through the probe, in response to a motion of the probe relative to the substrate carrier in the Z-direction; or
determining, for detecting a deflection of the probe tip in the X-direction, that the deflection signal is indicative of a pitch type rotation of the probe tip relative to a longitudinal axis through the probe, in response to a motion of the probe relative to the substrate carrier in an X-direction transverse to the Z-direction; or
determining, for detecting a deflection of the probe tip in the Y-direction, that the deflection signal is indicative of at least one of a roll type rotation or a yaw type rotation of the probe tip relative to a longitudinal axis through the probe, in response to a motion of the probe relative to the substrate carrier in a Y-direction transverse to the Z-direction.

11. The method according to claim 1, wherein the probe tip comprises a longitudinal section and one or more lateral structures;
wherein the longitudinal section extends from the cantilever in a working direction, wherein the working direction as parallel to the Z-direction in use; and
wherein the one or more lateral structures extend from the longitudinal section in a direction transverse to the working direction.

12. A scanning probe microscopy system comprising a substrate carrier for supporting a substrate including a substrate surface, a sensor head including a probe comprising a cantilever and a probe tip arranged on the cantilever, a deflection sensor for obtaining a deflection sensor signal indicative of a deflection of the probe tip, and
one or more actuators including: a Z-motion actuator for moving the probe tip or the substrate carrier in a Z-direction being a transverse direction relative to the sample surface, and a scanning actuator for moving the probe tip or the substrate carrier to move the probe tip relative to the substrate surface in a lateral direction which is transverse to the Z-direction,
wherein the system further comprises a control unit configured for receiving the deflection sensor signal from the deflection sensor and for controlling the one or more actuators, wherein the control unit comprises a plurality of signal processing units, and
wherein the control unit, for measuring a topography of a side wall of a structure on the surface of the substrate, is configured for performing a measurement at a measurement point including the steps of:
moving, using the Z-motion actuator, the probe and the substrate carrier relative to each other for approaching the probe tip towards the surface in a Z-direction perpendicular to the substrate surface;
determining that the probe tip is located adjacent the side wall;
establishing, using the scanning actuator and the deflection sensor, contact between the probe tip and the side wall while the probe tip is located adjacent the side wall; and
obtaining a lateral position of the probe tip while the probe tip is in contact with the side wall, such as to determine a current position of the probe tip on the side wall;
wherein the step of establishing contact is performed by a step of moving the probe tip relative to the substrate carrier in at least one lateral direction until contact between the probe tip and the side wall is established, the lateral direction being transverse to the Z-direction, wherein the moving is performed by applying a non-oscillatory motion on the substrate carrier or the probe.

13. The scanning probe microscopy system according to claim 12, wherein control unit for determining the current position of the probe tip is configured for at least one of:
obtaining, using the deflection sensor, an X-position of the probe tip while the probe tip is in contact with the side wall, wherein the X-position relates to a position in a first lateral direction; or
obtaining, using the deflection sensor, a Y-position of the probe tip while the probe tip is in contact with the side wall, wherein the Y-position relates to a position in a second lateral direction transverse to the first lateral direction; or
obtaining, using the deflection sensor, a Z-position of the probe tip while the probe tip is in contact with the side wall, wherein the Z-position relates to a position in the Z-direction.

14. The scanning probe microscopy system according to claim 12, wherein the control unit is further configured detecting, using the deflection sensor, an impact of the probe tip on the surface of the substrate during said moving of the probe tip towards the surface, and for determining a Z-position of an impact location on the surface.

15. The scanning probe microscopy system according to claim 12, the control unit being configured for comparing a current Z-position of the probe tip with a local maximum height of a structure on the surface as identified by the system, and for identifying the probe tip to be adjacent the side wall when the Z-position is below the local maximum height.

16. The scanning probe microscopy system according to claim 12, wherein for identifying the probe tip to impact at least one of the surface or the side wall, the control unit is configured for at least one of:
determining, using the deflection sensor for detecting a deflection of the probe tip in the Z-direction, that the deflection signal is indicative of a pitch type rotation of the probe tip relative to a longitudinal axis through the probe, in response to a motion of the probe relative to the substrate carrier in the Z-direction; or
determining, using the deflection sensor for detecting a deflection of the probe tip in the X-direction, that the deflection signal is indicative of a pitch type rotation of the probe tip relative to a longitudinal axis through the probe, in response to a motion of the probe relative to the substrate carrier in an X-direction transverse to the Z-direction; or
determining, using the deflection sensor for detecting a deflection of the probe tip in the Y-direction, that the deflection signal is indicative of at least one of a roll type rotation or a yaw type rotation of the probe tip relative to a longitudinal axis through the probe, in response to a motion of the probe relative to the substrate carrier in a Y-direction transverse to the Z-direction.

17. The scanning probe microscopy system according to claim 12, wherein the probe tip comprises a longitudinal section and one or more lateral structures;
wherein the longitudinal section extends from the cantilever in a working direction, wherein the working direction as parallel to the Z-direction in use; and
wherein the one or more lateral structures extend from the longitudinal section in a direction transverse to the working direction.

18. The method according to claim 2, wherein the method comprises, upon moving of the probe and the substrate relative to each other in the Z-direction, a step of detecting an impact of the probe tip on the surface of the substrate; and obtaining a Z-position of the probe tip upon said impact on the surface.

19. The method according to claim 7, wherein the step of obtaining the lateral position of the probe tip, further comprises maintaining contact between the probe tip and the side wall during said moving in the Z-direction and obtaining the lateral position at a plurality of Z-positions, to determine a shape of the side wall.

20. The scanning probe microscopy system according to claim 13, wherein the control unit is further configured detecting, using the deflection sensor, an impact of the probe tip on the surface of the substrate during said moving of the probe tip towards the surface, and for determining a Z-position of an impact location on the surface.
